(19) United States
(12) Patent Application Publication
(10) Pub. No.: US 2013/0258263 A1
(43) Pub. Date: Oct. 3, 2013

(54) ELECTRO-OPTICAL DEVICE AND ELECTRONIC APPARATUS

(71) Applicant: SEIKO EPSON CORPORATION, Tokyo (JP)

(72) Inventor: Masahiro Yasukawa, Chino-shi (JP)

(73) Assignee: Seiko Epson Corporation, Tokyo (JP)

(21) Appl. No.: 13/851,338

(22) Filed: Mar. 27, 2013

(30) Foreign Application Priority Data
Apr. 2, 2012 (JP) 2012-083628

(51) Int. Cl. G02F 1/1343

(52) U.S. Cl. CPC G02F 1/134309
USPC 349/138

(57) ABSTRACT

A liquid crystal device includes a pixel electrode provided on an interlayer insulation film of a pixel substrate, a seal material, a plurality of connection terminals provided outside the seal material, a first dummy electrode which is provided on the same layer as the pixel electrode in a first dummy region crossing a peripheral region of the pixel region and a region on which the seal material is disposed, a plurality of second dummy electrodes which are provided on the same layer as the pixel electrode in a second dummy region between the region on which the seal material is disposed and the plurality of connection terminals, a insulation film covering the pixel electrode, the first dummy electrode and the plurality of second dummy electrodes.

### BACKGROUND

1. Technical Field

The present invention relates to an electro-optical device and an electronic apparatus.

2. Related Art

As an electro-optical device, an active driving type liquid crystal device has been known in which a pixel electrode which is formed on one substrate of a pair of substrates, a transistor as a switching element which is provided corresponding to the pixel electrode and a liquid crystal layer as an electro-optical element are interposed between the pair of substrates.

In the one substrate, an interlayer insulation film is formed between a pixel circuit including the transistor and the pixel electrode. Since display irregularity may occur during driving if unevenness occurs on the pixel electrode facing the liquid crystal layer, planarization treatment is applied on a surface of the interlayer insulation film on which the pixel electrode is formed. A representative planarization treatment method includes a chemical-mechanical polishing treatment referred to as a Chemical Mechanical Polishing (CMP) treatment. If there is excessive unevenness on the surface of the interlayer insulation film before the CMP treatment is performed, there is a concern that a sufficient flatness may not be obtained even though the CMP treatment is performed. In addition, unevenness of the surface of the interlayer insulation film in a peripheral region of the pixel region, in which a plurality of pixel electrodes are disposed, affects the flatness of the pixel region. In addition, the productivity of the CMP treatment can be improved by a structure in which the unevenness of the surface of the interlayer insulation film is put in a range of a certain degree before the CMP treatment is performed.

For example, an electro-optical device has been disclosed in JP-A-11-72804. In the electro-optical device, a dummy pattern, which has a single layer or a plurality of layers formed of a conductive layer on a lower layer of the interlayer insulation film, is disposed in the vicinity of a terminal pad that is a portion of a peripheral region of the pixel region. According to JP-A-11-72804, an increase of the unevenness on the surface of the interlayer insulation film in the periphery of the terminal pad can be reduced compared to the pixel region by disposing the dummy pattern.

On the other hand, an example has been disclosed in JP-A-2008-64900 which addresses an issue which is caused by disposing such a dummy pattern in JP-A-11-72804 and reduces the issue. A liquid crystal display device has been disclosed in JP-A-2008-64900, in which the peripheral circuit region and the seal region include a dummy electrode having the same shape as the pixel electrode, and the dummy electrode is divided so as not to cross between two wirings which are connected to a driving circuit section of the peripheral circuit region and have different potentials. According to the liquid crystal display device, even though seal adhesive enters the peripheral circuit region on which the dummy electrode is provided and then spacer particles press and crush the dummy electrode, occurrence of short-circuit defects between the wirings described above can be suppressed.

In JP-A-2008-64900, there is a problem with a disposition in the seal region of the dummy electrode. On the other hand, in JP-A-11-72804, there is a problem that, for example, when a pair of substrates are taken out by scribing a pair of mother substrates formed of a glass, breakage of the wiring or electrical short-circuit (short) may occur by scratching of the dummy pattern provided in the vicinity of the terminal pad due to a foreign matter such as glass cullet (small pieces of glass) generated by scribing thereof.

### SUMMARY

The invention can be realized in the following forms or application examples.

### Application Example 1

According to Application Example 1, there is provided an electro-optical device including: a pair of substrates; a plurality of pixel electrodes provided on an interlayer insulation film of one substrate of the pair of substrates; a seal material bonding the pair of substrates; a plurality of external connection terminals which are provided outside from a seal region on which the seal material of the one substrate is provided; a first dummy electrode which is provided on the same layer as the pixel electrode in a first dummy region crossing a peripheral region of the pixel region on which the plurality of pixel electrodes are disposed and the seal region; a plurality of second dummy electrodes which are provided respectively and independently on the same layer as the pixel electrode in a second dummy region between the seal region and a terminal region on which the plurality of external connection terminals are provided; and an insulation film covering the plurality of pixel electrodes, the first dummy electrode and the plurality of second dummy electrodes.

In this case, the first dummy electrode is disposed on the first dummy region crossing the peripheral region surrounding the pixel region and the seal region, and the plurality of second dummy electrodes are disposed in the second dummy region between the seal region and the terminal region. Accordingly, the level of the unevenness of the surface of the insulation film is hardly changed in a region from the pixel region to the terminal region compared to a case where the dummy electrodes are not present. In other words, when the planarization treatment is applied to the insulation film, the flat surface can be realized in the region from the pixel region to the terminal region. In addition, since the second dummy electrode is disposed in the second dummy region between the seal region and the terminal region, damage to other wirings connected to the external connection terminal from the foreign matter generated in a scribing step can be reduced. In addition, since the plurality of second dummy electrodes are provided respectively and independently, the short-circuit between the wirings on the lower layer via the second dummy electrode can be reduced, even though the foreign matter comes into contact with the second dummy electrode. In other words, the electro-optical device can be provided in which the insulation film covering the pixel region is flat and then stable electro-optical characteristics is obtained, and the periphery of the external connection terminal is protected by the second dummy electrode.

### Application Example 2

In the electro-optical device according to Application Example 1, it is preferable that the electro-optical device further include a plurality of third dummy electrodes provided respectively and independently on the insulation film of the second dummy region, and the third dummy electrodes be formed by using a conductive material of which surface hardness is harder than that of the second dummy electrode.

In this case, a protection function of the second dummy electrode or other wirings which are provided on the lower layer thereof can be increased by the third dummy electrode.

### Application Example 3

In the electro-optical device according to Application Example 1 or 2, it is preferable that the second dummy electrode and the third dummy electrode be disposed so as to be overlapped in a plan view.

In this case, the second dummy electrode or other wirings which are provided on the lower layer thereof can be efficiently protected by the third dummy electrode.

### Application Example 4

In the electro-optical device according to Application Example 3, it is preferable that the third dummy electrode be larger than the second dummy electrode.

In this case, the second dummy electrode or other wirings which are provided on the lower layer thereof can be reliably protected by the third dummy electrode.

### Application Example 5

In the electro-optical device according to any one of Application Examples 1 to 4, it is preferable that the electro-optical device further include a common electrode which is disposed opposite to the pixel electrode in the other substrate of the pair of substrates and the same potential be applied to the first dummy electrode and the common electrode.

In this case, since the first dummy electrode and the common electrode have the same potential, a portion on which the first dummy electrode and the common electrode are overlapped in a plane can be a non-driving region (a non-display region), even though the electro-optical element is interposed between the first dummy electrode and the common electrode. In other words, the non-driving region (the non-display region) can be functioned as a parting portion surrounding the pixel region.

### Application Example 6

In the electro-optical device according to Application Example 5, it is preferable that the first dummy electrode have a plurality of dummy sections and the adjacent dummy sections be connected to each other, and a planar disposition pattern of the dummy section, the second dummy electrode and the third dummy electrode be the same as a planar disposition pattern of the pixel electrode in the pixel region.

In the case, since the disposition density of each dummy electrode is uniform in the same level as the pixel electrode, flatter surface can be realized if the planarization treatment is applied to the insulation film covering the pixel electrode or each dummy electrode.

### Application Example 7

In the electro-optical device according to any one of Application Examples 1 to 6, it is preferable that at least a portion of the external connection terminal be covered by the same conductive material as the conductive material configuring the third dummy electrode.

In this case, the surface of the plurality of external connection terminals can be protected from the damage due to contact with the foreign matter. In other words, the plurality of external connection terminals and external circuits can be reliably connected to each other.

### Application Example 8

According to Application Example 8, there is provided an electronic apparatus including the electro-optical device according to any one of Application Examples 1 to 7.

In this case, the electronic apparatus can be provided which has stable electro-optical characteristics and high reliability by reducing the damage to the electric circuit due to the foreign matter.

### BRIEF DESCRIPTION OF THE DRAWINGS

The invention will be described with reference to the accompanying drawings, wherein like numbers reference like elements.

FIG. 1 is a schematic plan view illustrating a configuration of a liquid crystal device.

FIG. 2 is a schematic cross-sectional view illustrating a structure of the liquid crystal device, which is cut in a line II-II in FIG. 1.

FIG. 3 is a schematic plan view illustrating a region in which various dummy electrodes are disposed.

FIG. 4 is a schematic plan view illustrating disposition of various dummy electrodes.

FIG. 5 is a schematic plan view illustrating the disposition of the dummy electrodes in the vicinity of an external connection terminal.

FIG. 6 is a schematic cross-sectional view illustrating a structure of a main portion of a liquid crystal panel which is taken along a line VI-VI in FIG. 4.

FIG. 7 is a schematic diagram illustrating a configuration of a projection type display device as electronic apparatus.

FIG. 8 is a schematic cross-sectional view illustrating a configuration of a third dummy electrode of a modification example.

### DESCRIPTION OF EXEMPLARY EMBODIMENTS

Hereinafter, an embodiment embodying the invention is described with reference to the drawings. In addition, the drawings which are used are appropriately enlarged or reduced so that a describing portion can be in a recognized state.

In addition, in the embodiment below, for example, when described as “on a substrate”, it describes that it is disposed so as to come into contact with on the substrate; it is disposed on the substrate via other constituents; or a portion is disposed so as to come into contact with on the substrate and another portion is disposed on the substrate via other constituents.

### First Embodiment

In the embodiment, as an example of an electro-optical device, an active-matrix type liquid crystal device including a thin film transistor (TFT) as a switching element of a pixel is described. The liquid crystal device may be, for example, preferably used as an optical modulator (liquid crystal light bulb) of a projection type display device (a liquid crystal projector) described below.

### Liquid Crystal Device

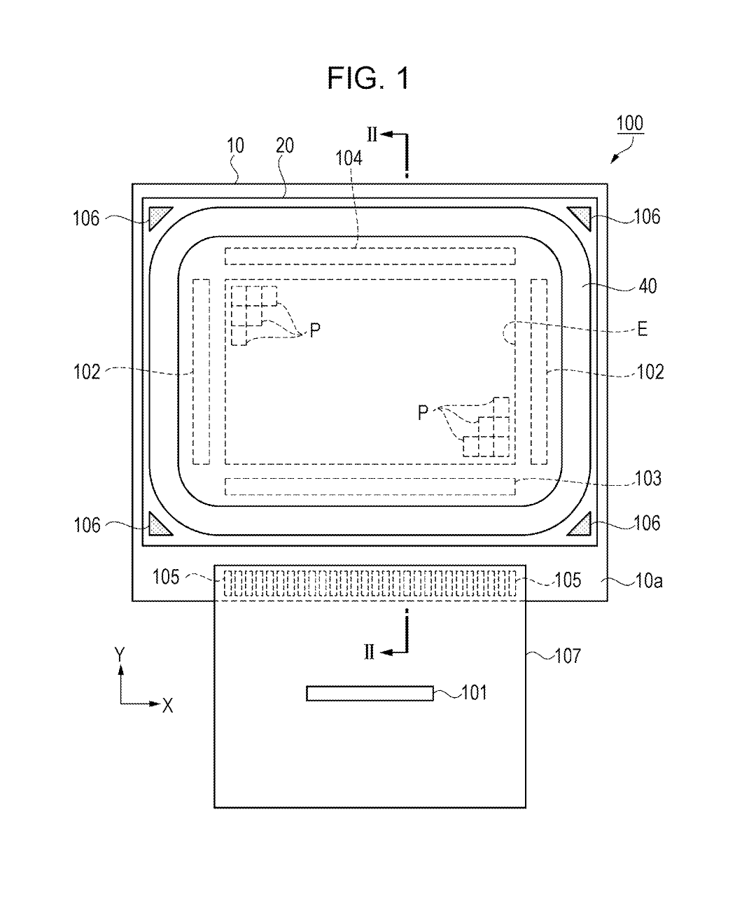

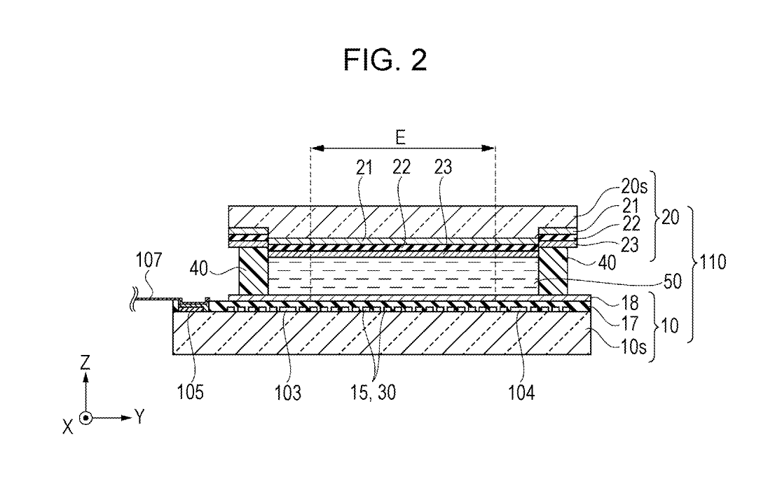

First, a schematic configuration of the liquid crystal device as the electro-optical device of the embodiment will be described with reference to FIGS. 1 and 2. FIG. 1 is a schematic plan view illustrating a configuration of the liquid crystal device and FIG. 2 is a schematic cross-sectional view illustrating a structure of the liquid crystal device which is cut in a line II-II in FIG. 1.

As illustrated in FIGS. 1 and 2, a liquid crystal device 100 of the embodiment has an element substrate 10 and an opposite substrate 20 which are disposed opposite to each other, and a liquid crystal layer 50 interposed by a pair of the substrates. A base material 10s of the element substrate 10 and a base material 20s of the opposite substrate 20 use, for example, a transparent quartz substrate or a glass substrate, respectively.

The element substrate 10 is larger than the opposite substrate 20 and both substrates are bonded each other using a seal material 40 disposed along an outer edge of the opposite substrate 20. In addition, the liquid crystal having a negative dielectric anisotropy is enclosed within a clearance thereof and then the liquid crystal layer 50 is configured. As the seal material 40, for example, adhesive such as a heat curable or an ultraviolet curable epoxy resin or the like is employed. In order to hold constantly the clearance of the pair of substrates, a spacer (not illustrated) is mixed in the seal material 40.

A pixel region E in which a plurality of pixels P are disposed in a matrix shape is provided inside the seal material 40. In addition, as described below in detail, various dummy electrodes are disposed in a region surrounding the pixel region E in the element substrate 10 side.

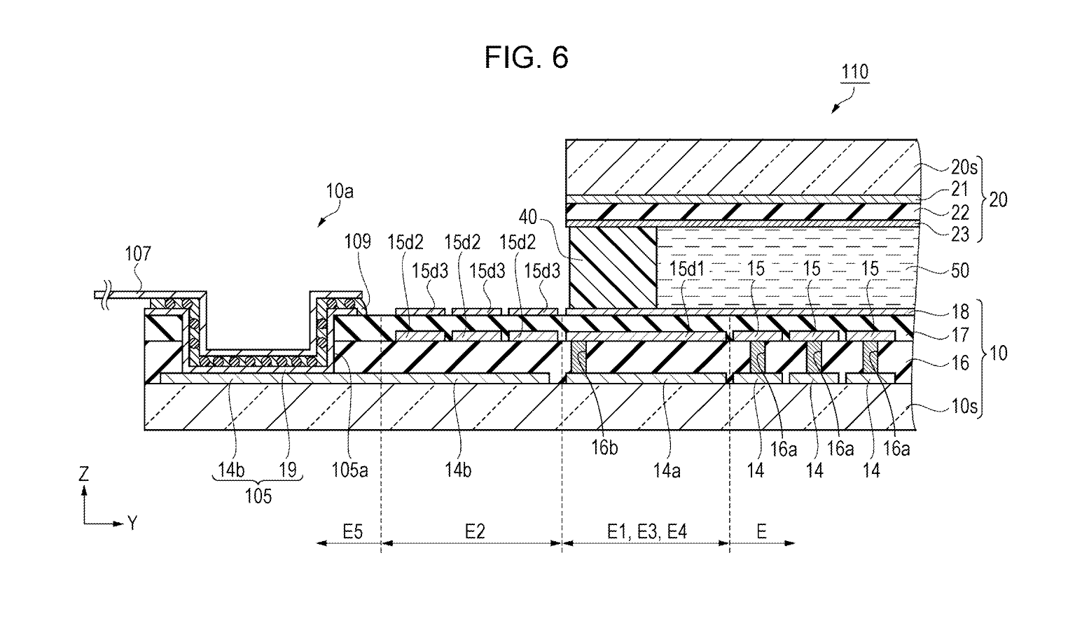

As illustrated in FIG. 2, the element substrate 10 has a light-reflective pixel electrode 15 and a thin film transistor (hereinafter, referred to as a TFT) 30 that is a switching element which are formed for each pixel P, a signal wiring (not illustrated), an interlayer insulation film 16 (see, FIG. 6) which covers the TFT 30 or the signal wiring, an insulation film 17 which covers the pixel electrode 15 and an oriented film 18, in the surface of the liquid crystal layer 50 side. In addition, a light shielding structure, which prevents the light from entering a semiconductor layer and switching operation from being unstable, is employed in the TFT 30. In the invention, the element substrate 10 as one substrate of the pair of substrates includes, at least, the base material 10s, the TFT 30 formed on the base material 10s, the signal wiring, the interlayer insulation film 16 (see, FIG. 6), the pixel electrode 15, the insulation film 17 and the oriented film 18.

The opposite substrate 20 as the other substrate of the pair of substrates includes, at least, the base material 20s, a common electrode 21 formed on the base material 20s, an insulation film 22 covering the common electrode 21 and an oriented film 23.

A thickness of a planar portion of the base material 20s which is overlapped with the seal material 40 is thinner than the other portion thereof. In addition, the thickness thereof is thinned up to the outer periphery of the base material 20s. The common electrode 21, the insulation film 22 and the oriented film 23 are also formed on the thinned portion thereof, respectively. If the thickness of the liquid crystal layer 50 is d, when the element substrate 10 and opposite substrate 20 are disposed opposite to each other across the liquid crystal layer 50, the seal material 40 includes the spacer (not illustrated) having a diameter greater than the thickness d of the liquid crystal layer 50, considering the thickness of the base material 20s coming into contact with the seal material 40. According to a cross-sectional structure of such an opposite substrate 20, the element substrate 10 and the opposite substrate 20 are disposed opposite to each other and can be adhered to each other by using the seal material 40 which includes the spacer having the diameter greater than the thickness d of the liquid crystal layer 50. Accordingly, variation of the thickness of the liquid crystal layer 50 can be suppressed.

The common electrode 21 is formed of, for example, a transparent conductive film such as indium tin oxide (ITO) and is electrically connected to the wiring of the element substrate 10 side by upper and lower conducive sections 106 (see, FIG. 1) provided on four corners of the opposite substrate 20.

In the insulation film 17 covering the pixel electrode 15 and the insulation film 22 covering the common electrode 21, a silicon oxide film is used which is formed by, for example, a CVD method, and a planarization process such as a CMP process is applied to the surface thereof.

The oriented films 18 and 23 are selected, based on an optical design of the liquid crystal device 100. In the embodiment, for example, an inorganic material, such as silicon oxide (SiOx) or the like, is deposited by a vapor-phase growth method such as oblique evaporation and an inorganic orientation film, which substantially vertically orients liquid crystal molecules having the negative dielectric anisotropy, is used.

Returning to FIG. 1, a sampling circuit 103 is provided between the seal material 40 and the pixel region E along a terminal section 10a of the element substrate 10. In addition, an inspection circuit 104 is provided between the seal material 40 and the pixel region E along a first side portion facing the terminal section 10a. Scanning line driving circuits 102 are provided between the seal material 40 and the pixel region E along a second and third side portions facing each other and orthogonal to the first side portion, respectively. A plurality of wirings (not illustrated), which connect two scanning line driving circuits 102, are provided between the seal material 40 of the first side portion and the inspection circuit 104. Hereinafter, description is given in which a direction along the terminal section 10a and the first side portion is referred to as X direction, and a direction along the second and third side portions is referred to as Y direction.

The TFT 30 is electrically connected to a scanning line explaining in the X direction and a data line explaining along the Y direction. The scanning line is electrically connected to an output end of the canning line driving circuit 102. The data line is connected to an output end of the sampling circuit 103 and an input end of the inspection circuit 104.

A wiring connected to the input end of the scanning line driving circuit 102 and the input end of the sampling circuit 103 is connected to external connection terminals 105 arranged in the terminal section 10a of the element substrate 10. A relay substrate 107 on which a TFT driving driver IC (TFTDr) 101 is mounted is connected to a plurality of the external connection terminals 105. For example, the relay substrate 107 is a flexible circuit substrate (FPC).

The TFTDr 101 sends a control signal such as a clock to the scanning line driving circuit 102. The scanning line driving circuit 102 sequentially sends a scanning signal to a plurality of scanning lines, based on the control signal. In addition, the TFTDr 101 sends a video signal and a selection signal to the sampling circuit 103, based on image information. A plurality of data lines are divided into a group in which, for example, N (N is a positive integer) is unit thereof and the sampling circuit 103 sends the video signal to the plurality of data lines in the group unit, based on the selection signal. The video signal is applied to the pixel electrode 15 via the TFT 30 of the pixels P selected by the scanning signal and the image is displayed. In addition, the configuration of the driving circuit which drives the pixels P is not limited to the embodiment.

Such a liquid crystal device 100 is a reflective type and employs an optical design of a normally white mode in which the pixels P are displayed bright when the pixels P are not driven or of a normally black mode in which the pixels P are displayed dark when the pixels P are not driven. A polarizing element or an optical compensation element such as a phase difference plate is disposed and used on the light incident side (the emitting side) depending on the optical design. In the embodiment, the normally black mode is employed.

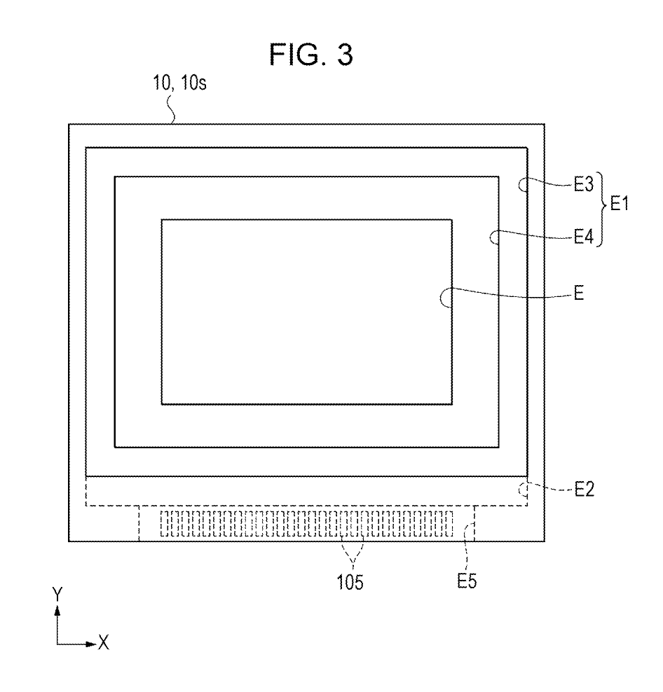

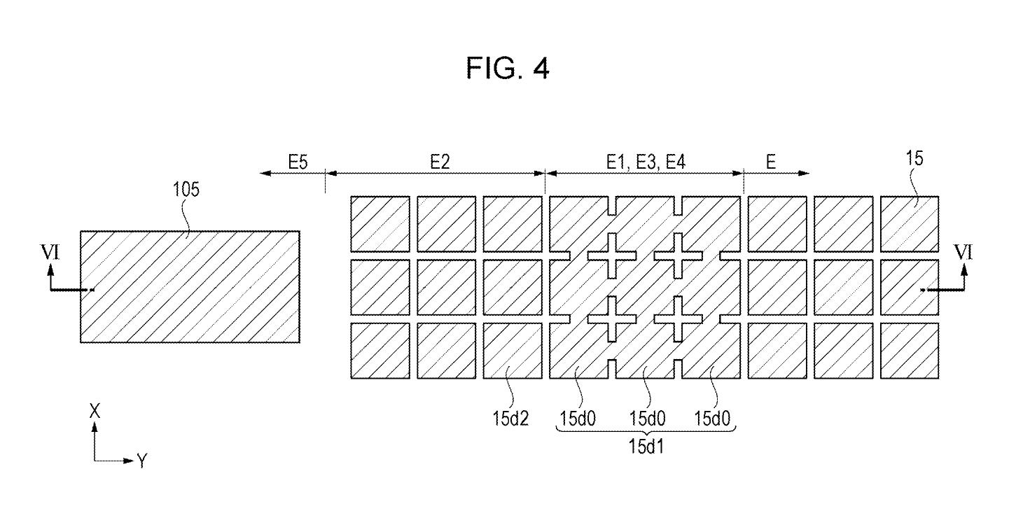

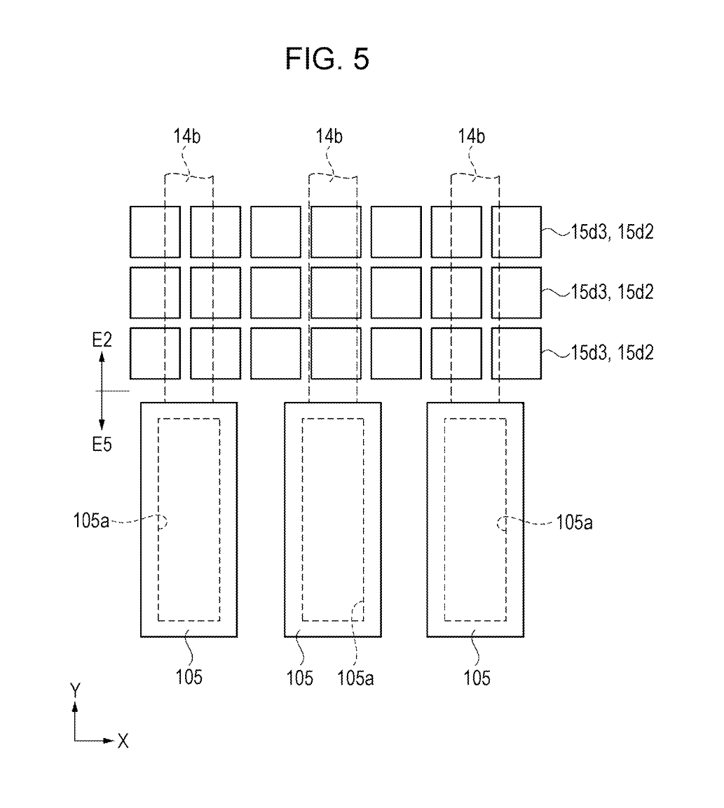

Next, disposition of the dummy electrode and a substrate structure according to the dummy electrode in the embodiment will be described with reference to FIGS. 3 to 6. FIG. 3 is a schematic plan view illustrating a region in which various dummy electrodes are disposed, FIG. 4 is a schematic plan view illustrating disposition of various dummy electrodes, FIG. 5 is a schematic plan view illustrating the disposition of the dummy electrodes in the vicinity of the external connection terminal and FIG. 6 is a schematic cross-sectional view illustrating a structure of a main portion of a liquid crystal panel which is taken along a line VI-VI in FIG. 4.

In the embodiment, as illustrated in FIG. 3, a region surrounding the pixel region E on the base material 10s of the element substrate 10 is divided into as follows. The region on which the seal material 40 is disposed is referred to as a seal region E3. A region between the seal region E3 and the pixel region E is referred to as a peripheral region E4. As described above, the scanning line driving circuit 102, the sampling circuit 103, the scanning circuit 104 and the wiring connecting between a peripheral circuit thereof and the plurality of external connection terminals 105 are provided on the peripheral region E4. A region on which the plurality of external connection terminals 105 are arranged is referred to as a terminal region E5.

A combined region of the seal region E3 and the peripheral region E4 is referred to as a first dummy region E1 of the invention. A region between the seal region E3 and the terminal region E5 is referred to as a second dummy region E2 of the invention. The insulation film 17 described above is formed to cover the regions. Accordingly, the dummy electrodes are disposed on the first dummy region E1 or the second dummy region E2 of the periphery of the pixel region E, respectively by applying a planarization treatment such as the CPT treatment on the insulation film 17.

As illustrated in FIG. 4, a substantially square pixel electrode 15 is disposed on the pixel region E in a matrix shape in the X direction and the Y direction. A plurality of dummy sections 15d0 are disposed on the first dummy region E1 surrounding the pixel region E, similar to the pixel electrode 15 in the matrix shape and the first dummy region E1 has a first dummy electrode 15d1 in which the adjacent dummy sections 15d0 are connected to each other. A plurality of second dummy electrodes 15d2 are disposed, respectively and independently on the second dummy region E2 between the first dummy region E1 and the terminal region E5, similar to the pixel electrode 15 in the matrix shape. As described below in detail, shapes of the dummy section 15d0 and the second dummy electrode 15d2 are substantially the same as the pixel electrode 15. Then, the dummy sections 15d0 and the second dummy electrodes 15d2 are provided on the same wiring layer as the pixel electrode 15 on the base material 10s. The dummy sections 15d0 and the second dummy electrodes 15d2 are provided on the first dummy region E1 and the second dummy region E2, respectively in a substantially same disposition pattern, in other words, a substantially same disposition density (an electrode area per unit area). Accordingly, when the insulation film 17 is formed and the CMP treatment is applied so as to cover the pixel region E, the first dummy region E1 and the second dummy region E2, substantially flat surface state is obtained in each of the regions.

In addition, FIG. 4 schematically illustrates the disposition of the dummy sections 15d0 or the second dummy electrode 15d2 with respect to the pixel electrode 15. The number of the dispositions of the dummy sections 15d0 or the second dummy electrodes 15d2 in the X direction and the Y direction is not limited to three.

In addition, as illustrated in FIG. 5, a plurality of third dummy electrodes 15d3, which are overlapped with respect to the plurality of second dummy electrodes 15d2, are disposed respectively and independently in the matrix shape on the second dummy region E2. The shapes of the second dummy electrode 15d2 and the third dummy electrode 15d3 are the substantially same as each other and are substantially square shapes. In other words, a disposition pattern of the third dummy electrodes 15d3 is also the same as the pixel electrode 15.

Next, disposition structure of various dummy electrodes on the base material 10s will be described in detail with reference to FIG. 6. In addition, illustration of the TFT 30 or the wiring connected to the TFT 30 formed on the base material 10s is omitted in FIG. 6.

As illustrated in FIG. 6, first, a relay layer 14 corresponding to each of the pixel electrodes 15 is formed in the pixel region E on the base material 10s. The relay layer 14 is a conductive layer which is provided to electrically connect between the TFT 30 and the pixel electrode 15 in each of pixels P (see, FIG. 1). Similarly, a relay layer 14a corresponding to the first dummy electrode 15d1 is formed in the first dummy region E1. The relay layer 14a functions as a wiring for applying a potential to the first dummy electrode 15d1. Then, a relay layer 14b is formed across the second dummy region E2 and the terminal region E5 which are the outside from the first dummy region E1. The relay layer 14b configures a portion of the external connection terminal 105. In addition, as described above, the relay layer 14b is for transmitting the video signal or various control signals and is formed for each of the external connection terminals 105 (see, FIG. 5).

The relay layers 14, 14a and 14b are formed on the same wiring layer, and can employ a structure in which, for example, conductive layers of a wiring material of aluminum (Al) or a metal compound thereof, or of different wiring materials are laminated. In other words, after the wiring material such as Al is deposited on the base substrate 10s, the deposition is patterned and the relay layer 14 is formed in the pixel region E for each of the pixels P and the relay layer 14a is formed in the first dummy region E1, and the relay layer 14b is formed in the second dummy region E2.

Next, the interlayer insulation film 16 is formed by covering the relay layers 14, 14a and 14b. The interlayer insulation film 16 can use, for example, a None-doped Silicate Glass (NSG) film, a Boron Silicate Glass (BSG), a Boron Phosphorus Silicate Glass (BPSG) film or combination thereof, which may be formed by a plasma CVD method. Then, the planarization treatment such as the CMP treatment is applied on the interlayer insulation film 16. Since the relay layers 14, 14a and 14b described above are disposed on a lower layer of the interlayer insulation film 16, the pixel region E and the surface of the periphery thereof can be flattened after the planarization treatment is performed. The thickness of the interlayer insulation film 16 is appropriately 500 nm to 1000 nm after the planarization treatment is performed.

Next, a contact hole 16a electrically connecting the relay layer 14 and the pixel electrode 15, and a contact hole 16b electrically connecting the relay layer 14a and the first dummy electrode 15d1 are formed in the interlayer insulation film 16 on which the planarization treatment is performed. As a conductive material configuring the contact holes 16a and 16b, tungsten (W) or the like may be exemplified.

In addition, before the planarization treatment is performed on the interlayer insulation film 16, the contact holes 16a and 16b may be formed and then the planarization treatment is performed.

Next, the interlayer insulation film 16 is covered and a light reflective conductive film formed from, for example, Al, an alloy of Al and other metals or the like is formed. The pixel electrode 15 is formed in the pixel region E, the first dummy electrode 15d1 is formed in the first dummy region E1 and the second dummy electrode 15d2 is formed in the second dummy region E2 by patterning the light reflective conductive film. In other words, the second dummy electrode 15d2 is in an electrically floating state. The thickness of the light reflective conductive film is substantially 100 nm to 200 nm.

Next, the insulation film 17 is formed by covering the pixel electrode 15, the first dummy electrode 15d1 and the second dummy electrode 15d2. The insulation film 17 can use, for example, a NSG film. Then, the planarization treatment such as the CMP treatment is applied to the insulation film 17. The thickness of the insulation film 17 is substantially 200 nm to 400 nm after the planarization treatment is performed. In other words, it is preferable that the planarization treatment be performed after the insulation film 17 is formed with a thickness of at least two times of the thickness of the light reflective conductive film so that unevenness, which is generated on the surface of the insulation film 17 caused by the pixel electrode 15 or each dummy electrode, is in a flat state.

Next, a groove section (a concave section) 105a, which passes through the interlayer insulation film 16 and the insulation film 17, and exposes the relay layer 14b on a bottom portion, is formed on a position corresponding to the external connection terminal 105.

Next, transparent conductive film, for example, such as ITO is deposited on the surface of the insulation film 17 including the groove section (the concave section) 105a. A thickness of the transparent conductive film is substantially 100 nm to 200 nm. The third dummy electrode 15d3 is formed on a position which is overlapped with the second dummy electrode 15d2 by patterning the transparent conductive film. In addition, a conductive layer 19 coming into contact with the relay layer 14b is formed on the groove section (the concave section) 105a (see, FIG. 5). In other words, the external connection terminal 105 is configured of a portion of the relay layer 14b exposed to the bottom surface of the groove section 105a which is formed by being depressed in the terminal section 10a and a conductive layer 19 which is formed by coming into contact with a portion of the exposed relay layer 14b and by covering the groove section 105a. Since the conductive layer 19 is a transparent conductive film of which surface hardness is harder than that of the relay layer 14b, the conductive layer 19 also functions as a protection layer in the external connection terminal 105.

Next, the oriented film 18 is formed at least across the pixel region E and the first dummy region E1. The element substrate 10 and the opposite substrate 20 formed as described above, are bonded by the seal material 40, and the liquid crystal is charged in the clearance thereby forming the liquid crystal layer 50.

For example, heat curable anisotropic conductive film (ACF) 109 is laid on the terminal region E5 of the terminal section 10a and the relay substrate 107 is pressed by heat, and the anisotropic conductive film (ACF) is cured by heat. Accordingly, the external connection terminal 105 and the relay substrate 107 are electrically connected to each other.

The pixel electrode 15 is electrically connected to the TFT 30 via the contact hole 16a and the relay layer 14 and is controlled to be switched. In other words, a driving potential is applied to the pixel electrode 15 depending on the video signal by the TFT 30. Accordingly, an electric field is generated across the liquid crystal layer 50 between the common electrode 21 on which a fixed potential (LCCOM) is applied and the pixel electrode 15, and the liquid crystal layer 50 is driven depending on the video signal.

In addition, in the embodiment, the potential (LCCOM) that is the same potential applied to the common electrode 21 is applied to the first dummy electrode 15d1 of the first dummy region E1 surrounding the pixel region E via the relay layer 14a and the contact hole 16b. Accordingly, the electric field is not generated across the liquid crystal layer 50 between the common electrode 21 and the first dummy electrode 15d1. In other words, the peripheral region E4 of the first dummy region E1 surrounding the pixel region E is always in a normally black state. Accordingly, the peripheral region E4 functions as a parting portion surrounding the pixel region E. In addition, the potential applied to the common electrode 21 is not limited to the fixed potential and a potential which is varied periodically may be applied.

In addition, it is also conceivable that the third dummy electrodes 15d3 is further disposed on the first dummy region E1 so as to overlap the first dummy electrode 15d1. However, since the third dummy electrodes 15d3 is in an electrically floating state, there is a concern that the potential may be changed between the common electrode 21 and the first dummy electrode 15d1 in the peripheral region E4, and it is conceivable that the peripheral region E4 functioning as the parting portion may be affected. In addition, there is a concern that the LCCOM potential may be changed. Accordingly, it is preferable to avoid the third dummy electrode 15d3 being disposed on the first dummy region E1.

According to the embodiment, following effects are obtained.

(1) The pixel electrode 15 is disposed on the lower layer of the insulation film 17 in the pixel region E and the first dummy electrode 15d1 is disposed in the first dummy region E1 surrounding the pixel region E in the same wiring layer as the pixel electrode 15. In addition, the second dummy electrode 15d2 is disposed on the second dummy region E2 between the first dummy region E1 and the terminal region E5. Accordingly, since the pixel electrode 15, the first dummy electrode 15d1 and the second dummy electrode 15d2 are formed in a state of substantially the same disposition pattern (the disposition density) on the lower layer of the insulation film 17, a flat surface is obtained throughout the second dummy region E2 from the pixel region E, when the planarization treatment such as the CMP treatment is performed on the insulation film 17.

(2) Furthermore, the third dummy electrodes 15d3 which have substantially the same outer shape as each other are formed on the position which is overlapped with the second dummy electrodes 15d2 by inserting the insulation film 17 covering the second dummy electrodes 15d2 into the terminal section 10a coming into contact with the relay substrate 107. Since the third dummy electrodes 15d3 is formed by using the transparent conductive film (a metal oxide film), such as ITO which has a harder surface hardness compared to the second dummy electrodes 15d2, the second dummy region E2 of the terminal section 10a can be protected. In addition, the external connection terminal 105 has a portion of the relay layer 14b which is exposed in the terminal section 10a and the conductive layer 19 which is formed by coming into contact with the relay layer 14b and by using the same transparent conductive film. In other words, even though foreign matter or the like comes into contact with the terminal section 10a in a scribing step in which the terminal section 10a is exposed, since the second dummy electrodes 15d2 or the third dummy electrodes 15d3 are provided electrically independently, it is possible to reduce occurrence of disconnection or short-circuit (short) by damage of the relay layer 14b as the wiring of the lower layer thereof due to the foreign matter.

(3) The same fixed potential (LCCOM) as the common electrode 21 is applied to the first dummy electrode 15d1 disposed in the first dummy region E1 surrounding the pixel region E. Accordingly, the liquid crystal layer 50 is always in the normally black state in the peripheral region E4 between the seal region E3 and the pixel region E. Thus, when the liquid crystal device 100 (the liquid crystal panel 110) is used as a reflective type liquid crystal light bulb in a projection type display device described below, since the light incident to the peripheral region E4 does not interfere the display light reflected in the pixel region E by being reflected immoderately, it is possible to realize a high contrast display.

(4) In other words, for example, the terminal section 10a is unlikely to be damaged by the foreign matter or the like in the scribing process and the liquid crystal device 100 (the liquid crystal panel 110) having a high display quality can be provided.

### Second Embodiment

### Electronic Apparatus

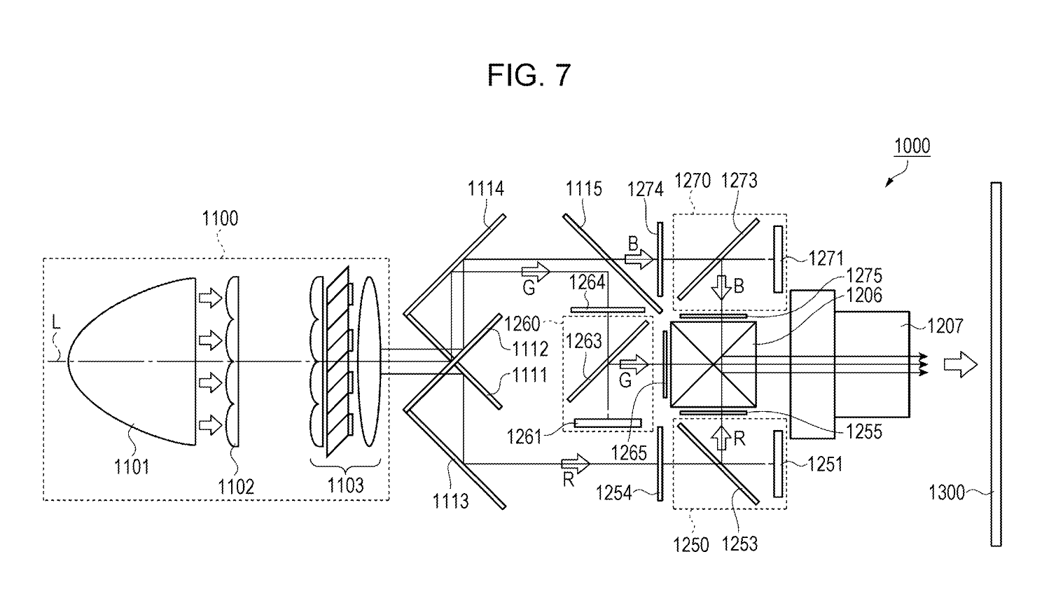

Next, the projection type display device as the electronic apparatus of the embodiment will be described with reference to FIG. 7. FIG. 7 is a schematic diagram illustrating a configuration as the electronic apparatus.

As illustrated in FIG. 7, a projection type display device 1000 as the electronic apparatus of the embodiment includes a polarization illuminating device 1100, three dichroic mirrors 1111, 1112 and 1115, two reflective mirrors 1113 and 1114, three reflective type liquid crystal light bulbs 1250, 1260 and 1270 as light modulation elements, a cross dichroic prism 1206, and a projection lens 1207.

The polarization illuminating device 1100 is schematically configured of a lamp unit 1101 as a light source consisting of a white light source such as a halogen lamp, an integrator lens 1102 and a polarization conversion element 1103.

Polarized luminous flux emitted from the polarization illuminating device 1100 is incident to the dichroic mirror 1111 and the dichroic mirror 1112 which are disposed orthogonal to each other. The dichroic mirror 1111 as a light separation element reflects the red light (R) in the incident polarized luminous flux. The dichroic mirror 1112 as the other light separation element reflects the green light (G) and the blue light (B) in the incident the polarized luminous flux.

The reflected red light (R) is reflected again by the reflective mirror 1113 and is incident to the liquid crystal light bulb 1250. Meanwhile, the reflected green light (G) and blue light (B) are reflected again by the reflective mirror 1114 and are incident to the dichroic mirror 1115 as the light separation element. The dichroic mirror 1115 reflects the green light (G) and transmits the blue light (B). the reflected green light (G) is incident to the liquid crystal light bulb 1260. The transmitted blue light (B) is incident to the liquid crystal light bulb 1270.

The liquid crystal light bulb 1250 includes a reflective type liquid crystal panel 1251, a wire-grid polarization plate 1253 as a reflective type polarization element.

The liquid crystal light bulb 1250 is disposed in such a manner that the red light (R) reflected by the wire-grid polarization plate 1253 is incident in a direction perpendicular to the incident surface of the cross dichroic prism 1206. In addition, an auxiliary polarization plate 1254 compensating the degree of the polarization of the wire-grid polarization plate 1253 is disposed on the incident side of the red light (R) in the liquid crystal light bulb 1250. In addition, the other auxiliary polarization plate 1255 is disposed along the incident surface of the cross dichroic prism 1206 in the emitting side of the red light (R). In addition, when the polarization beam splitter is used as the reflective type polarization element, a pair of auxiliary polarization plates 1254 and 1255 may be omitted.

Configurations and disposition of each configuration of the reflective type liquid crystal light bulb 1250 are the same as other reflective type liquid crystal light bulbs 1260 and 1270.

Each color light incident to the liquid crystal light bulbs 1250, 1260 and 1270 is modulated, based on the image information, and is incident again on the cross dichroic prism 1206 via the wire-grid polarization plates 1253, 1263 and 1273. In the cross dichroic prism 1206, each color light is synthesized, the synthesized light is projected on a screen 1300 by the projection lens 1207 and the image is enlarged thereby being displayed.

In the embodiment, as the liquid crystal light bulbs 1250, 1260 and 1270, the reflective type liquid crystal device 100 is applied in the above first embodiment.

According to the projection type display device 1000 described above, since the reflective type liquid crystal device 100 is used in the liquid crystal light bulbs 1250, 1260 and 1270, a bright image can be projected and the reflective type projection type display device 1000 having a high reliable quality in the electric circuit can be provided.

The invention is not limited to the above embodiments and can be appropriately changed within a range which is not contrary to the gist or sprit of the invention which is read from claims and the entire specification. In addition, an electro-optical device and electronic apparatus to which the electro-optical device is applied are also included in a technical range of the invention according to such a change. Various modification examples may be provided besides the above embodiments. Hereinafter, modification examples are described.

### Modification Example 1

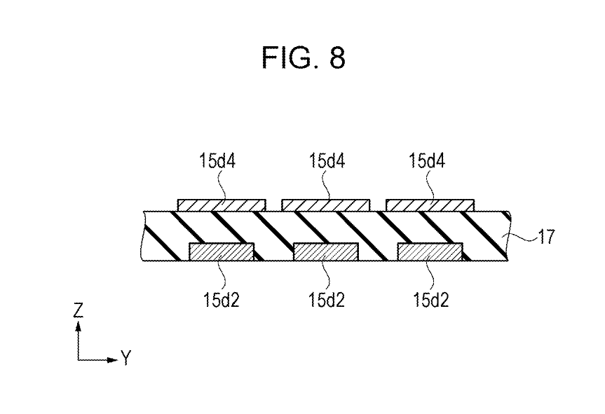

The disposition of the third dummy electrode 15d3 in the second dummy region E2 is not limited to the embodiment. FIG. 8 is a schematic plan view illustrating a configuration of the third dummy electrode of the modification example. For example, as illustrated in FIG. 8, a third dummy electrode 15d4 of the modification example is disposed across the insulation film 17 with respect to the second dummy electrodes 15d2. The third dummy electrodes 15d4 are formed independently on the insulation film 17 and are slightly larger than the second dummy electrodes 15d2 when viewed in a plan view. Accordingly, since the clearance between the third dummy electrodes 15d4 is narrower than that of the above first embodiment, the second dummy electrodes 15d2 and the wirings positioned on the lower layer thereof can be reliably protected.

### Modification Example 2

The outer shape and the size of the second dummy electrodes 15d2 and the dummy section 15d0 of the first dummy electrode 15d1 are substantially the same as the pixel electrode 15; however, the invention is not limited to the embodiment. When the planarization treatment is applied to the insulation film 17, a flat surface may be obtained in the pixel region E and to the periphery thereof, and, at this point, the outer shape or the size thereof may be different from each other if the disposition density of the dummy electrodes is substantially the same as the disposition density of the pixel electrode 15 in the lower layer of the insulation film 17. Specifically, the disposition pitch of the second dummy electrodes 15d2 or the third dummy electrodes 15d3 provided on the second dummy region E2 of the terminal section 10a is preferably smaller than the disposition pitch of the external connection terminal 105 in the X direction in that the short-circuit is unlikely to occur due to the foreign matter.

### Modification Example 3

In the above first embodiment, the third dummy electrode 15d3 or the conductive layer 19 covering the exposed relay layer 14b, which is formed of the transparent conductive film (the metal oxide film) such as the ITO, is provided on the insulation film 17; however, the invention is not limited to the embodiment. Both or any one of the third dummy electrode 15d3 and the conductive layer 19 may not be provided.

### Modification Example 4

In the above first embodiment, the groove section 105a is formed for each external connection terminal 105; however, the invention is not limited to the embodiment. For example, as illustrated in FIG. 3, the groove section may be formed throughout the terminal region E5. Accordingly, the external connection terminal 105 can be connected to the relay substrate 107 via the ACF 109 without occurrence step of the interlayer insulation film 16 and the insulation film 17 between the external connection terminals 105 arranged in the x-axis direction.

### Modification Example 5

The electro-optical device on which the invention may be applied is not limited to the reflective type liquid crystal device 100. When the pixel electrode 15 and the common electrode 21 are applied to the transmission type liquid crystal device by using the transparent conductive film such as the ITO and then the insulation film 17 is deposited by covering at least the pixel electrode 15, the same effects as (1) to (4) of the above embodiments are achieved. In addition, the invention is not limited to the liquid crystal device and may be applied, for example, to an organic electroluminescent device (an organic EL device) including an organic light emitting layer or to an electrophoretic display device including an electrophoretic layer having electrophoretic particles, as an electro-optical device between the pixel electrode 15 and the common electrode 21.

### Modification Example 6

The electronic apparatus on which the liquid crystal device 100 of the above first embodiment is not limited to the projection type display device 1000 of the above embodiments. For example, the invention can be applied to a display section of an information terminal apparatus such as a projection type head-up display (HUD), a direct-view type head-mounted display (HMD), an e-book, a personal computer, a digital still camera, a liquid crystal television, a viewfinder type or a monitor direct-view type video recorder, a car navigation system, an electronic diary, a POS, or the like.

The entire disclosure of Japanese Patent Application No. 2012-083628, filed Apr. 2, 2012 is expressly incorporated by reference herein.

What is claimed is:

1. An electro-optical device comprising:
a pair of substrates;
a pixel electrode provided on an interlayer insulation film of one substrate of the pair of substrates;
a seal material bonding the pair of substrates;
a plurality of connection terminals which are provided outside from the seal material of the one substrate;
a first dummy electrode which is provided on the same layer as the pixel electrode in a first dummy region crossing a peripheral region of the pixel region on which the pixel electrode is disposed and a region on which the seal material is disposed;
a plurality of second dummy electrodes which are provided on the same layer as the pixel electrode in a second dummy region between the region on which the seal material is disposed and the plurality of connection terminals; and
an insulation film covering the pixel electrode, the first dummy electrode and the plurality of second dummy electrodes.

2. The electro-optical device according to claim 1, further comprising:
a plurality of third dummy electrodes provided respectively and independently on the insulation film of the second dummy region,
wherein the third dummy electrodes are formed by using a conductive material of which surface hardness is harder than that of the second dummy electrode.

3. The electro-optical device according to claim 1,
wherein the second dummy electrode and the third dummy electrode are disposed so as to be overlapped in a plan view.

4. The electro-optical device according to claim 3,
wherein the third dummy electrode is larger than the second dummy electrode.

5. The electro-optical device according to claim 1, further comprising:
a common electrode which is disposed opposite to the pixel electrode in the other substrate of the pair of substrates,
wherein the same potential is applied to the first dummy electrode and the common electrode.

6. The electro-optical device according to claim 5,
wherein the first dummy electrode has a plurality of dummy sections and the adjacent dummy sections are connected to each other, and
wherein a planar disposition pattern of the dummy section, the second dummy electrode and the third dummy electrode is the same as a planar disposition pattern of the pixel electrode in the pixel region.

7. The electro-optical device according to claim 1,
wherein at least a portion of the connection terminal is covered by the same conductive material as the conductive material configuring the third dummy electrode.

8. An electronic apparatus comprising:
the electro-optical device according to claim 1.
